(19) United States
(12) Patent Application Publication
(10) Pub. No.: US 2021/0027246 A1
(43) Pub. Date: Jan. 28, 2021

(54) Convenient Shipment System

(71) Applicants: Kashif Rana, Fremont, CA (US); Naweed Muhammad, Fremont, CA (US)

(72) Inventors: Kashif Rana, Fremont, CA (US); Naweed Muhammad, Fremont, CA (US)

(21) Appl. No.: 16/935,226

(22) Filed: Jul. 22, 2020

Related U.S. Application Data
(60) Provisional application No. 62/878,345, filed on Jul. 25, 2019.

(51) Int. Cl. G06Q 10/08; G06Q 30/02; G06Q 50/26; G06Q 50/30; G06K 7/14; G06N 20/00; H04L 29/06; H04L 29/08

(52) U.S. Cl. CPC G06Q 10/08355; G06Q 30/0201; G06Q 10/0836; G06Q 10/0832; G06Q 50/265; G06Q 50/30; G06Q 20/085; G06N 20/00; H04L 63/0861; H04L 67/26; G06Q 10/0831; G06Q 30/0233; G06Q 30/0215; G06K 7/1417

(57) ABSTRACT

A method of delivery system incorporating a user terminal, driver/shipper terminal and webserver where the driver/shipper is required to make an account distinguishing on the basis of Zip/Postal code for online delivery system. In the further embodiment of the invention the system coordinates Clients and Volunteers with the objective that Client's shipment is carried by the Volunteer whose personal travel plan happens to coincide with the O-, T-, or D-points of the Shipment. In this revolutionary shipping channel, a Client starts a shipping order on C-portal or C-app and selects from a variety of shipping options of varying cost and time. The CCS, through its analysis of historical trends of Shipment movement speeds and paths between given O-, D-nodes, assists the Client in making the best choice. To make the system smart artificial intelligence technology and techniques can also be used. The system further allows detour, no cut-off time, Receiver's options, speedup or slowdown delivery options, tracking, retracting, rerouting, interception and reward point's setup as well.

### CROSS-REFERENCE TO RELATED APPLICATIONS

This application claims priority to the following U.S. Provisional Patent Application, of which is hereby incorporated by reference in its entirety: U.S. Ser. No. 62/878,345 filed 25 Jul. 2019.

### BACKGROUND

### Field of the Invention

This invention relates in general to user facilitation and in particular to desktop and mobile application and optimization systems, methods and apparatuses. The present invention relates to resource management through identification, coordination and optimization of need/demand and resource/supply through a plurality of tools comprising of hardware, software, and other electronic and mechanical gadgets, in a cost-effective, efficient and environment-friendly way. In particular, this invention relates to a novel and non-obvious mechanism to address needs of a consumer or of a business for local, national and international shipping, without negatively impacting the environment by virtue of piggybacking already mobilized sources on the road, in the air and sea.

### Background of Invention

Shipping of documents, consumer products, business consumables, health products and essentially every conceivable item (collectively, referred to as “Shipment” hereafter) shipped through any courier service is transported through a system that comprises of an extensive setup including, among other things, storage/quarantine areas, and a large fleet of commercial utility vehicles. Such a system has multiple inherent problems and inadequacies which have remained unaddressed to date. One such problem stems from the use of fleet of vehicles which exists and is mobilized exclusively for transporting Shipments. This requires a great deal of capital investment for purchase and maintenance and it adds to the traffic density and above all it adds to the carbon footprint. Trucks (light, medium and heavy duty) contribute 41% to transportation greenhouse gases as per U.S. Environmental Protection Agency (EPA) (2018) Inventory of U.S. Greenhouse Gas Emissions and Sinks: 1990-2016. UPS, for instance, operates over 119,000 trucks worldwide and 547 aircrafts resulting in 1138 domestic and 1182 international daily flights. (https://pressroom.ups.com/pressroom/ContentDetailsViewer.page?ConceptType=FactSheets&id=1426321563187-193 Accessed Jul. 19, 2019). FedEx, another major courier in the USA, operates over 85,000 vehicles and 681 aircrafts. (https://about.van.fedex.com/our-story/company-structure/express-fact-sheet/Accessed Jul. 19, 2019). One can easily imagine the extent of environmental impact of the aforementioned couriers. The present invention bears the real potential to significantly curtail the use of such fleets and hence cause a reduction in transportation greenhouse gases.

Another inherent limitation of a traditional courier service is ‘the cut-off time’ for a shipment for a given day or a type of service. Failure to drop-off a shipment before the cut-off time results in service delays or denials. This invention does away with this limitation and offers a service with no cut-off times whatsoever. It is rather as seamless as the time flow is. This invention allows for shipping around the clock and around the year with no off-hours. One more limitation of existing courier services is the necessity to ‘drop-off’ the shipment at a designated place. Current invention does not impose such a necessity and offers an option to pick up from the origin of the shipment. Such a pickup, even if provided by the existing couriers, adds up cost and more importantly adds to greenhouse gas emission due to additional miles traveled generally by a large vehicle.

Yet another limitation of the typical courier services is the lack of the option, for the Client, to retract the Shipment once it has been dropped off. Sometimes, need for shipment ceases to exist after drop-off. Sometimes, initial delivery time no longer remains relevant because need changes to a quicker delivery or slower delivery (in instances where receiving party is not available). Anyway, should a need or preference for the shipping service change, Client is unable to address that change of need in the existing courier systems. The present invention nets a delivery system over which a Shipment floats like a kite and Client can hold the string anytime to steer, speedup or slowdown its movement or even cause the retrieval of the Shipment—in a hassle-free and guaranteed manner. This feature of the present invention can lead to elimination of undesirable/unsuitable deliveries.

A further limitation of the existing systems is that the status/location of a Shipment is available only in discrete blocks of time during transit. The present invention offers a real-time and continuous visibility of the Shipment's status and location.

COVID-19 pandemic crises have tested the robustness and reliance of myriad of services such as medical care, telecommunication, food and other household items' supply chains to name a few. Result of this ‘stress test’ have exposed shallow capacity and reliance thresholds of many of the services. One service sector which experienced an exponential rise in demand is courier service. This sector has clearly demonstrated a lack of elasticity to accommodate spiked demand in these changed and challenging times. This invention presents an enormous advantage over existing solutions.

As such, there is a need in the art for a system that addresses the historical/inherent limitations of existing courier services. A system that is in sync with 21st century's demands, challenges and bounties and as such offers the Client control, convenience, choice and cost-savings and yet such system does not belong to the contemporary solutions which adversely affect the environment.

Given the importance and long history of shipping services, there are multiple inventions the prior art that deal with the shipment needs and methods, but nothing has been found to approach the problem as the current invention does. For instance, a system, method and process for order and delivery of classified goods and services through an amalgamated drive-thru complex bearing US patent 2,004,024,9497A1 is issued to AutoCart LLC. The system and procedure in discussion comprises, in one embodiment, a system, method and process for delivery of classified goods and serviced items through a vehicle drive-thru facility, the facility having a plurality of vehicle drive-thru pick-up portals for goods or services orderable via an electronic or computer medium. As per another embodiment, a process for operating a multi-lane, drive-thru, consolidated retail or commercial supercenter mall featuring specialized facility designs, high-speed order processing, warehouse management, order consolidation and delivery system of amalgamated classified goods or services is proposed. This system is adapted to apply a blend of shared staffing and shared services provision, information technology and enterprise management tools, and integrated process designs to meet the needs of a variety of tenant businesses operating within a single unit.

Another prior art example is that of a delivery system and method for vehicles and the like bearing US patent 2,002,008,289,3A1 issued to United Parcel Service of America Inc. The patent discloses a product delivery system that moves products from manufacturing plant to destination. Particularly applicable to the delivery of vehicles from vehicle assembly plants to dealerships, the system utilizes a centralized management organization overseeing independent entities in a delivery network, and provides a management team with improved visibility of and improved tools for operating the network, such as a tracking system by which managers in many parts of the network have access to the status of individual products and network facilities, a simulation tool by which managers can test scenarios for the purpose of changing product routing plans based on predicted capacity and bottlenecks, and a planning tool that can facilitate preparation of product routing plans in response to information from the other tools. The system also uses feedback from the delivery network to influence the sequence in which the products are manufactured.

A method and system for vehicle-initiated delivery of advanced diagnostics based on the determined need by vehicle bearing U.S. Pat. No. 6,181,994B1 is issued to International Business Machines Corp Current Invention Said patent reveals advanced diagnostics to be loaded into a vehicle on demand with results being sent back to the diagnostic center, possibly requiring a more refined selection of diagnostics based on the results of the previous tests. Thus, a new generation of network vehicle communicates with diagnostic centers, via cellular telephone, wireless communications and Internet access via wireless communication link, and provides a rich networking topology that allows onboard computers or microprocessors to obtain problem diagnostics and data while on the road.

A package delivery notification system and method bearing U.S. Pat. No. 6,975,998B1 is issued to ArrivalStar Inc. A package delivery notification system reports impending package deliveries and precisely notifies recipients of when to expect the deliveries. The package delivery notification system utilizes memory, a communications device, and a system manager. Package data identifying a package that is to be delivered to a recipient is stored in the memory. The package data indicates that the recipient is to receive the package and indicates the expected time for the package to be delivered. When the package is assigned to a vehicle that will deliver the package to a premise of the recipient, the system manager transmits, via the communications device, a notification message to the recipient. The notification message preferably indicates the approximate time that the package is expected to arrive.

A residential delivery system and method bearing U.S. Pat. No. 7,587,345B2 is issued to SimonDeliverscom Inc. The patent discloses a method and a system for delivery, establishes a delivery subsector for a distribution facility, adjusts at delivery area within the delivery subsector, plans a flexible delivery route in the delivery area, and completes deliveries. Deliveries locations closest to the distribution facility are not assigned to the flexible delivery route such that additional delivery resources are required only in areas in proximity with the distribution facility.

An intelligent express delivery box system adopting two-dimension code payment and mode bearing Canadian patent 1,0479,4823A is issued to a Chinese inventor. The patent reveals an intelligent express delivery box system adopting two-dimensional payment code and a mode relates to an intelligent express delivery box including an intelligent self-taking box, in particular to a self-service device and an intelligent logistics device serving as logistics terminals. The intelligent express delivery box system adopting a two-dimensional payment code comprises a master control module, a lock control panel, an electronic lock, a power supply, a display screen and a cabinet body, wherein the power supply is connected with the master control module, the master control module is connected with the lock control panel, the lock control panel is connected with the electronic lock, and the display screen is connected with the master control module. The intelligent express delivery box system comprises an intelligent express delivery box, a server and a Client-side, wherein the intelligent express delivery box is connected with server through a network, the Client-side and the server are connected through a network, the master control module generates two-dimensional codes with different encoding contents according to charge account numbers, users and charge sums, and the display screen displays the two-dimensional codes.

The object of the present invention is to provide a system and a method for a delivery system which uses and leverages existing traffic on the road, in the air or sea. The system comprises of plurality of tools including hardware, software, and other electronic and mechanical gadgets. Apart from the managing/operational personnel, the system would involve Clients (who ship something) and Volunteers (who move a Shipment from point A to Point B where point A is not necessarily the origin and point B is not necessarily the destination). Volunteers could be paid or un-paid drivers who move the shipment from one location to another. In this system following terms are used:
Shipment: Any item that is being sent, through the service(s) of this invention, from point A to point B. By way of examples, and without any limitation, an item can be a document, a commodity, an electronic gadget, an artifact, natural product, or anything which has ever been shipped or could have been shipped through any courier service or similar means as known to those skilled in the art.
Clients: A person, a group of persons, a family, an organization, or a business or an entity who, in general, receives services from this domain, specifically, who send a Shipment.
Receiver: A person, a group of persons, a family, an organization, or a business or an entity to whom a Shipment is sent.
Origin Node (O-Node): The point at which something begins or rises or from which it derives. Here the term ‘Origin Node’ refers to the point of origin of the Shipment.
Destination Node (D-Node): The place to which someone or something is going or being sent. Here the term ‘Destination Node’ refers to the final delivery address for a Shipment.
Transition Node (T-Node): Transitory-stay location(s) of the Shipment. A location where one Volunteer drops off for another Volunteer to pick up and carry the Shipment to the next node. Else, a T-Node can act a pickup location by Receiver (or in some cases by the Sender) if so, requested by the Receiver or the Sender.
Volunteer: A person who freely offers to take part in an enterprise or undertake a task. Here the term ‘Volunteer’ refers to a driver or a traveler (road, air, sea) who carriers the Shipment.
Hub: A storage system installed at T-Nodes.
Bin: A receptacle in a Hub where a given Shipment securely resides during transit state (after being dropped off and waiting to be picked up by the next Volunteer, the Receiver, or the Sender). A Bin is a functional unit of the Hub.
X-Miles: Extra miles travelled by the Volunteer to pick or drop-off a shipment from a node.
Reward Points: The points a Volunteer earns by delivering a Shipment from one node to another.
Client Portal (C-Portal): Website portal used by the Clients to prepare a Shipment.
Client App (C-App): A smart device app used by the Clients to prepare a Shipment.
Volunteer App (V-App): A smart device app used by the Volunteers to facilitate shipment. Which includes but is not limited to map of the route, identification of new pickup and drop-off points, code to retrieve and drop-off a package, Volunteer preference and any facilitation. Information, assistance, technology, or service needed by the Volunteer to participate in the pick-up and/or drop-off operation.
Central Control System (CCS): The main computing and controlling unit of the system which may or may not employ artificial intelligence.
Service Zone: The geographical zone within which the delivery service is provided.
Stagnant Phase: The phase of a Shipment when it is not moving and is stored at a T-Node.
Mobile Phase: The phase of a Shipment when it is moving (in a vehicle, aircraft, boat, or ship) and is getting closer to D-Node.
Delivery Speed: The term ‘Delivery Speed’ refers to the promised/requested time interval between Shipment emergence at the O-node and drop-off at D-Node and availability for pick-up by the Receiver.
Security Level: The term ‘Security Level’ refers to the level of custodial care and security of the Shipment during service period. It encompasses the mechanism and requirement of drop-off and choice a Volunteer with certain level of security clearance.
Service Level: The term ‘Service Level’ as it applies here represents a certain combination of Delivery Speed choice and Shipment Security Level. The invention embodies offering several Service Levels.

None of the previous inventions and patents, taken either singly or in combination, is seen to describe the present invention as claimed. Hence, the inventors of the present invention propose to resolve and surmount existent technical difficulties to eliminate the aforementioned shortcomings of the prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking into account the entire specifications, claims, drawings, and abstract as a whole.

It is the general object of this invention to provide a new and improved delivery/courier system which uses and leverages existing traffic on the road or in the air or sea.

It is also the object of the invention to provide a new and improved technology and method for mainly two types of users of this system i.e., Clients and Volunteers.

It is the object of the current invention to provide an online portal and/or an app for a smart device for the Client to ship, monitor, modify, redirect, retrieve, hasten, slowdown, or cancel a shipment and to provide an app for the smart device of the Volunteer to discover (through automatic notifications or active search), spot, pick-up, drop-off a Shipment and to access, bill, and receive a delivery fee or reward points for the Shipment. A Client app or portal for the Client is C-App or C-Portal and app for the Volunteer is V-App.

It is also the object of the current invention to install a network of Hubs which are essential ensembles individual, isolated and secure Bins for the drop-off, pick-up and storage Shipments.

It is also the object of the current invention to enable the hubs in such a way that a Volunteer can pickup and drop-off a Shipment with a quick stop or while driving. Hub includes single or multiple drive-through channels equipped with a system that identifies which package should be given to the Volunteer based on the Volunteer's route and preference. Same drive-through may also be used to collect any shipment Volunteer wants to drop-off. A mechanical, robotic system or a human runs the operation in the background which sorts and manages the packages and brings the desired package for the Volunteer to carry or collects a package the Volunteer has brought for drop-off. A Hub is as advance as switching package from a high speed moving vehicle on a highway, which requires infrastructure on/and around the highway and some modification on the Volunteer's vehicle—all such developments are within the scope of current invention.

It is the object of current invention to provide an application which looks like a simple interface in the form of a map and is compatible with IOS, Android or any other commonly used mobile or desktop operating systems.

It is also the object of this invention to provide an operationally and economically efficient system which can provide swift, secure, Client-managed, operationally-rich, flexible and cost-effective shipment solutions.

Moreover, it is the object of the current invention to provide an active system where the given package is assigned a Bin based package's size and weight. Conceived size of the Bin is at least about 8 cubic inches, at least about 27 cubic inches, at least about 125 cubic inches, at least about 512 cubic inches, at least about 1331 cubic inches, at least about 2744 cubic inches, at least about 4913 cubic inches, at least about 6859 cubic inches, at or least about 8000 cubic inches. A given Hub is comprised a plurality of Bin sizes.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Anywhere in the world, traffic flow (road, air, sea) is akin to Brownian motion of the fluids—abundant, persistent, sustained, and most importantly random enough to reach every nook and corner. Given the societal shipping needs, the traffic phenomenon can be capitalized on by smart engagement. Every transportation utility can be safely considered as bearing lower payload than its capacity. This observation or assessment becomes even more exciting and meaningful when considering the fact that most shipments would not add any appreciable payload. The present invention relates to these phenomena and seeks to revolutionize the purpose of traffic and travelling.

The present invention is a method and a system to coordinate Clients and Volunteers with the objective that Client's shipment is carried by the Volunteer whose personal travel plan happens to coincide with the O-, T-, or D-Nodes of the Shipment. In this revolutionary shipping channel, a Client starts a shipping order on C-portal or C-app and selects from a variety of shipping options of varying costs and delivery speeds. The CCS, through its analysis of historical trends of Shipments movement speeds and paths between given O-, D-nodes, assists the Client in making the best choice. To make the system smarter, the use of artificial intelligence (AI) or machine learning technology and techniques are also contemplated in this invention. The service zone is sprinkled with T-nodes (comprising of one or more hubs) so that a Client leaves a shipment at any nearby or suitable T-node if Client chooses so. Else, a Shipment is picked up from the O-node. Once the CCS acknowledges a shipping order, it identifies Volunteers who potentially can carry (between any 2 nodes) and/or deliver the Shipment all the way at D-node. Identification of a suitable Volunteer is based on Volunteer's travel path, availability, and preferences. The CCS aims for a quick and cost-effective solution with minimum possible X-miles. For that reason, T-nodes' distribution gravitates to be near a busy and/or main, travel paths in the service zone. A Volunteer registers him/herself using V-app and in the registration, process indicates his/her preferences for engagement, as well as usual/frequent travel plans. Subsequently, when a registered Volunteer starts a personal journey and also feels like Volunteering, he/she opens the V-App, indicates the final destination of the current journey and allows access to his/her current location (which updates in the CCS as Volunteer's position changes). The CCS matches Volunteer's preferences and travel path with the available Shipments, along that travel path, and notifies the Volunteer. The Volunteer can then pick up one or more Shipments from O-, or T-Nodes and drop them off at any T-, or D-Nodes. This way a Shipment either reaches its final destination (D-Node) or gets closer to it by reaching a new T-Node.

The Pick-up and Drop-off Process as per preferred embodiment includes a Client, who chooses to drop off a Shipment at a T-Node, he/she approaches a T-Node of his/her choice (or the one suggested by the CCS) and uses a handheld smart device to interact with the Hub through wireless, NFC, Wi-Fi, LiFi, Bluetooth, RF signal or any other suitable commination protocol, known to those skilled in the art, to identify and open an available Bin. Alternatively, a QR code or a bar code, generated during shipping process, is scanned at the Hub and Hub opens the available/suitable Bin. Scanning can be through IR scanner or camera or any other known scanning technology. Once the Shipment is placed in the Bin, the CCS instantly acknowledges its presence and starts finding an appropriate Volunteer to move it further. When a Volunteer approaches the Hub to pick up (or drop-off) a Shipment, he/she uses V-App and above-mentioned methods to identify and open a relevant Bin. Additionally, the Hub may need to authenticate Volunteer's identity though images matching, driver license scanning or any other suitable biometric authentication parameter. More than one identity authentication methods are also contemplated in the invention in case of sensitive and expensive Shipments which require extra security and as per Security Level ordered by the Client.

A Volunteer as per further embodiment may detour from original intended path, in which case CCS promptly alerts and guides the Volunteer to drop-off the shipment if it is drifting away from its destination. Volunteer then drops off the Shipment at nearby T-Node with minimum X-miles accrued.

Receiver's Options:

A Receiver can passively wait for the delivery at D-Node or he/she can intercept it at any T-Node of choice. For a Receiver to be able to intercept the Shipment, the Client provides the Receiver a system-defined and authorized identity authentication which is a unique QR code, a bare code, a sound bite, an image, a text, or other real-time commination either directly between the Receiver's hand-held device and Client's device or through mediation of Hub or CCS. Authentication can be a combination of two or more of above methods as warranted by the Security Level of the service.

No Cut-Off Time:

As traffic flows nonstop, a Client can ship a Shipment at any time without any limitation of the time of the day, day of the week, and it is amenable to be picked up and moved along soon after shipping. Therefore, this invention offers a true 24/7/365 shipping service.

Speedup or Slowdown the Delivery:

Should a need or preference of the Client change after shipping, a delivery can hastened or slowed, in instances where the urgency emerges or when Receiver is not available to take the delivery. In other words, the Client can change the Delivery Speed, Security Level and Service Level after the shipment. Alternatively, the Receiver can also request a change in Delivery Speed, Security Level and Service Level if so, permitted by the Client.

Tracking:

At any point in time, the Client can track the location of the shipment through C-Poratl or C-App. If the Receiver is given such access by the Client, he/she can also determine the location of the shipment. During transient state, for the security and privacy of the Volunteer, the precise location of the Shipment will be off by a few to 100s of meters. This offset value will be dynamic and will be determined by the CCS in light of location, traffic density, Volunteer preference e and other parameters.

Retracting, Rerouting, and Interception:

Unlike existing courier services, at any time a Shipment can be re-routed to new destination, back to O-Node or any T-Node, or even a new D-Node of Client's choice. A Client can also intercept a Shipment at any point in time and can pick up from a T-Node. Similarly, the Receiver can re-route or intercept a Shipment at any point in time and can pick up from a T-Node, id so authorized by the Client either at the time of shipping or during transit.

Hub:

A hub is be a compartmentalized smart cabinet which interacts with the Client, or the Volunteer and in some cases with the Receiver, in a variety of ways and acts as a custodian of the shipment at T-node during stagnant phase of the Shipment.

Reward Points:

For each mile traveled, a Volunteer will accrue reward points which can be cashed out for their monitory value or these points can be used at select services for discounts. Calculations of Rewards Points are based on several factors including, without limitation, distance travelled, day and time of travel, delivery urgency factor, track record of the Volunteer and security clearance level of the volunteer. As per preference of the Volunteer, these Reward Point can be converted into local or any other currency and paid to the Volunteer or these can be deemed at any participating Reward Point partner(s).

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art can appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A method of a delivery system comprising:
a screen interface to display on the user's output screen,
providing said application for running on mobile devices, laptops, or desktop screen,
a user terminal;
means for collecting information especially Zip/postal code from said end user by a display of one or more screens of selectable information at the beginning of execution of the application;
whereby said application WILL collect demographic information and/or directly from said end user.
The method of claim I, used so that the collected demographic information is to be used specifically for targeting specific set of users.
The method of claim I, used so that delivery system for shippers and drivers can be made efficient, leveraging existing traffic on road air or sea.
A method of alerting, guiding and re-assigning a T-Node in case a Volunteer detours (i.e., a Shipment in Mobile Phase drifts away from original intended path), whereby the Volunteer WILL drop-off the Shipment at nearby T-Node with minimum X-miles accrued.
The method of claim 1, where QR code and scanning technology WILL be utilized for packages.

II: A system and procedure to revolutionize the purpose of traffic and travelling:
where the Clients and Volunteers and coordinated;
where the Client' shipment is carried by the Volunteer;
where the Volunteer personal travel plan is matched with the O-, T-, or D-points of the Shipment;
where a match between Volunteers' travel plan and available Shipment creates a searchable pickup opportunity and/or triggers alert(s) for Volunteer;
where a Client starts a shipping order on C-portal or C-app and selects from a variety of shipping options of varying cost and delivery-time;
where the system assists the Client in making the best choice;

III: A system for efficient delivery system:
where a smart system with or without use of artificial intelligence technology and techniques is utilized to provide service in a Service Zone;
where a Service Zone is sprinkled with T-nodes (comprising of one or more hubs) for Shipment drop-off by the Client or a Volunteer and pickup by the Receiver or Volunteer;
where a Shipment can be picked up from O-Node.
A CCS system aiming for a quick and cost-effective solution with minimum possible X-miles where:
the registration process indicates his/her preferences for engagement and usual/frequent travel plans;
a Volunteer registers him/herself using V-app;
a registered Volunteer starts a journey and with V-App, indicates the final destination of the current journey and allows access to it his/her current location;
the CCS matches Volunteers' preferences and travel path with the available Shipments along the way and notifies the Volunteers;
the Volunteer can pick up one or more Shipments from O-, or T-Nodes and drop them off at any T-, or D-Nodes.
A system for delivery system where an efficient pick and drop process is exhibited and where:
a Client who chooses to drop off a Shipment at T-Node, can use a handheld smart device to interact with T-Node;
the receiving Hub can communicate through wireless, NFC, WiFi, LiFi, Bluetooth, RF single or any other suitable commination protocol to identify the user (Volunteer or Client), indicate/assign and open an relevant/available Bin as the case may be;
a QR code or a bar code, generated during shipping process, can be scanned at the Hub and Hub WILL open the available/suitable Bin;
the scanning can be achieved through IR scanner or camera or any other scanning technology known to those skilled in the art;
the shipment order is placed, the CCS instantly acknowledges its presence and matches appropriate Volunteer(s) to move it, notifies them of this pickup opportunity;
the Volunteer approaches the Hub to pick up (or drop-off) a Shipment, he/she uses V-App and above-mentioned methods to identify and open a relevant Bin;
the Hub may need to authenticate Volunteer's identity though images matching, driver license scanning or any other suitable biometric authentication parameter;
more than one identity authentication methods are also contemplated in the invention in case of sensitive and expensive Shipments which require extra security.
